(19) United States
(12) Patent Application Publication
(10) Pub. No.: US 2013/0136970 A1
(43) Pub. Date: May 30, 2013

(54) POWER SOURCE APPARATUS, AND VEHICLE AND POWER STORAGE SYSTEM EQUIPPED WITH THE POWER SOURCE APPARATUS

(71) Applicant: Sanyo Electric Co., Ltd., Moriguchi City (JP)

(72) Inventors: Yoshihiro Kurokawa, Kasai City (JP); Masao Kume, Hirakata City (JP)

(73) Assignee: Sanyo Electric Co., Ltd., Moriguchi City (JP)

(21) Appl. No.: 13/681,985

(22) Filed: Nov. 20, 2012

(30) Foreign Application Priority Data
Nov. 30, 2011 (JP) 2011-261336

(51) Int. Cl. H01M 2/10

(52) U.S. Cl. CPC H01M 2/1077
USPC 429/99

(57) ABSTRACT

The power source apparatus is made up of an arrangement of a plurality of battery blocks having a plurality of rectangular battery cells with endplates disposed at the ends. A base-panel that carries battery blocks disposed in a horizontal plane, and floor-panels disposed on top of battery blocks and configured with upper surfaces capable of carrying other battery blocks are provided. Battery block endplates have upper attachment sections to attach a floor-panel disposed on the upper surfaces of the endplates, and lower attachment sections to attach a base-panel or floor-panel disposed at the lower surfaces of the endplates.

### BACKGROUND OF THE INVENTION

1. Field of the Invention

The present invention relates to a power source apparatus having a plurality of stacked rectangular battery cells, to a vehicle and power storage system equipped with the power source apparatus; in particular, to a power source apparatus installed on-board an electric vehicle such as a hybrid vehicle, fuel-cell vehicle, electric vehicle, or electric auto-bike; or to a power source apparatus configured to supply high current such as in a home or industrial power storage application.

2. Description of the Related Art

A power source apparatus with a plurality of battery cells is used, for example, in automotive applications as the power source in a vehicle such as a hybrid vehicle or electric vehicle. This type of power source apparatus is made up of battery blocks having a plurality of stacked battery cells. In particular, recent demand for high power output has resulted in adoption of configurations that are combinations of a plurality of battery blocks (refer to Japanese Laid-Open Patent Publication 2011-100619). For example, in FIG. 17, the power source apparatus 700 has four battery blocks 710 disposed in a horizontal plane and enclosed in a case 712.

However, if a large number of battery blocks are used in this configuration, the dedicated area (footprint) of the case will increase proportionally with the number of battery blocks. When many battery blocks have to be disposed in a limited space such as in a vehicle power source apparatus, strict space limits apply and installation of a power source apparatus that holds many battery blocks in a large case is problematic.

Consequently, configurations that stack battery blocks vertically as well as horizontally have been devised (refer to Japanese Laid-Open Patent Publication 2011-108652). For example, FIG. 18 shows a structure that establishes a plurality of support columns 814 on the upper surface of a battery block 810 and attaches battery blocks 810 on top of one another via the support columns 814.

However, this battery block configuration requires separate preparation of the support columns 814, which are made of flexible material, and solid mounting of those support columns 814 on the upper surfaces of the battery cells via adhesive material. Unfortunately, these operations entail additional processing steps and increase cost.

In contrast, configurations have also been conceived that do not use support columns, but rather partition the case into a plurality of layers where battery blocks are loaded.

However, to make it easy to load battery blocks into the various layers of this type of case, it is necessary to establish sufficient tolerance in the width and height dimensions of each layer of the case. As a result, case bulkiness becomes a problem.

For the original objective of disposing as many battery blocks as possible in a limited space, increasing the bulkiness of the case is counter productive.

The present invention was developed with the object of resolving these types of prior art problems. Thus, it is a primary object of the present invention to provide a power source apparatus, and vehicle and power storage system equipped with the power source apparatus that can efficiently dispose a plurality of battery blocks in a limited space.

### SUMMARY OF THE INVENTION

The power source apparatus for the first aspect of the present invention is made up of an arrangement of a plurality of battery blocks 10 each having a plurality of rectangular battery cells with endplates 7 disposed at both ends. Further, the power source apparatus can be provided with a base-panel 41 that carries battery blocks 10 disposed in a horizontal plane, and floor-panels 40 disposed on top of battery blocks 10 having upper surfaces capable of carrying other battery blocks 10. The endplates 7 can be provided with upper attachment sections 52 to attach floor-panels 40 disposed on the upper surfaces of the endplates 7, and lower attachment sections 54 to attach a base-panel 41 or floor-panels 40 disposed at the bottom surfaces of the endplates 7. With this structure, it is possible to stack battery blocks vertically with intervening floor-panels, and depending on the allotted space, the power source apparatus can be partitioned into two or three layers. This enables increased flexibility in the spatial disposition of battery blocks. Further, by supporting floor-panels with the endplates, there is no need to provide floor-panel supporting structures on battery cells within the battery blocks simplifying the battery block stacking structure. Since battery blocks can be attached in close proximity to each other via the floor-panels, the battery block stacking structure also contributes to size reduction. In addition, by establishing structures necessary for vertical layering at the endplates, there is no need for vertical layering structures at battery cells within the battery blocks, and this contributes to simplifying the battery block stacking structure and to size reduction.

In the power source apparatus for the second aspect of the present invention, the lower attachment sections 54 can be through-holes that extend from the upper to lower surfaces of the endplates 7, and a base-panel 41 or floor-panel 40 disposed at the lower surfaces of the endplates 7 can be attached via fastener material 58 inserted through the through-holes. Further, the upper attachment sections 52 can be positioned laterally (in a direction perpendicular to the battery block 10 vertical stacking direction) on the endplates 7 outward or inward of the upper openings of the lower attachment section 54 through-holes. This structure allows fastener material such as bolts to be inserted from the top of the lower attachment sections and attached to a base-panel or floor-panel.

In the power source apparatus for the third aspect of the present invention, the upper attachment sections 52 can be positioned on the endplates 7 laterally (in a direction perpendicular to the battery block 10 vertical stacking direction) inward of the lower attachment sections 54. With this structure, when a battery block is stacked on the upper surface of another battery block with an intervening floor-panel, interference between floor-panel attachment points can be avoided by laterally displacing the upper and lower level battery blocks.

In the power source apparatus for the fourth aspect of the present invention, the upper attachment sections 52 can be formed to protrude upward in the battery block 10 stacking direction, and surfaces at the upper openings of the lower attachment section 54 through-holes can be formed at locations (in the battery block 10 stacking direction) below the tops of the upper attachment sections 52. When endplates are attached to a base-panel using fastener material such as bolts, this structure allows the bolt heads to be disposed in locations that are recessed relative to the upper attachment sections. Further, when a floor-panel is attached on top, attachment can be made without protrusion of bolt heads from the endplates, and exterior size increase can be avoided.

In the power source apparatus for the fifth aspect of the present invention, to attach a battery block 10 on the upper surface of a floor-panel 40, fastener material 58 can be inserted from the upper surfaces of the battery block 10 endplates 7 through the lower attachment section 54 through-holes and fastened to the floor-panel 40 while extending from the underside of the floor-panel 40 by a given height. Further, the floor-panels 40 can be provided with underside connecting structures 44 at upper attachment section 52 locations that extend by a given height toward the upper attachment sections 52 on lower level battery blocks 10. In this configuration with a floor-panel attached via panel attachment holes in the underside connecting structures, the underside of the floor-panel stands-off from the tops of the lower level battery blocks by a given height to separate the underside of the floor-panel from the upper surfaces of the battery blocks and establish electrical isolation. In addition, by accommodating the given height of bolt extension from battery blocks attached on the upper surface of the floor-panel with the stand-off separation, height increase due to floor-panel attachment can be restrained.

In the power source apparatus for the sixth aspect of the present invention, the floor-panels 40 and base-panel 41 can be provided with battery block attachment holes to attach battery block 10 endplates 7 on the upper surfaces. Further, the battery block attachment holes can be configured with blind-nuts or T-nuts 43 (anchored nuts that do not rotate relative to the floor or base-panel), and the bottom surfaces of the endplates 7 can be provided with nut cavities 48 to accommodate the blind-nuts 43. With this structure, when the endplates are attached to a floor-panel or base-panel, there is no need to thread nuts onto bolts extending from the underside. This results in labor-saving for attachment operations, avoids having to allocate space for nuts on the undersides of the floor-panels and base-panel, and contributes to overall size reduction.

The vehicle for the seventh aspect of the present invention can be equipped with the power source apparatus cited above.

The power storage system for the eighth aspect of the present invention can be equipped with the power source apparatus cited above. The above and further objects of the present invention as well as the features thereof will become more apparent from the following detailed description to be made in conjunction with the accompanying drawings.

### BRIEF DESCRIPTION OF THE DRAWINGS

FIG. 1 is an oblique view showing the external appearance of a power source apparatus for an embodiment of the present invention;

FIG. 2 is an exploded oblique view showing the gas duct, pressure plate, and sealing material separated from the power source apparatus of FIG. 1;

FIG. 3 is an exploded oblique view showing a battery cell, separator, and endplate separated from the power source apparatus of FIG. 1;

FIG. 4 is a plan view showing battery block connection in the horizontal plane;

FIG. 5 is an exploded oblique view showing vertical layering of the battery blocks;

FIG. 6 is a plan view showing connection of a plurality of battery blocks;

FIG. 7A is a plan view of a battery block, and FIG. 7B is an end view of the battery block in FIG. 7A;

FIG. 8 is a cross-section view showing battery blocks as shown in FIG. 7 layered with an intervening floor-panel;

FIG. 9 is an end view showing a battery block endplate;

FIG. 10 is a side view of the battery block in FIG. 9;

FIG. 11 is a side view of the layered configuration of battery blocks shown in FIG. 8;

FIG. 12 is an oblique view showing the blind-nuts of a floor-panel;

FIG. 13 is an oblique view showing a plurality of battery blocks with gas exhaust ducts connected;

FIG. 14 is a block diagram showing an example of a hybrid vehicle, which is driven by a motor and an engine, equipped with a power source apparatus;

FIG. 15 is a block diagram showing an example of an electric vehicle, which is driven by a motor only, equipped with a power source apparatus;

FIG. 16 is a block diagram showing an example of a power source apparatus used in a power storage application;

FIG. 17 an exploded oblique view showing a prior art power source apparatus; and

FIG. 18 an exploded oblique view showing battery blocks used in another prior art power source apparatus.

### DETAILED DESCRIPTION OF THE EMBODIMENTS

The following describes embodiments of the present invention based on the figures. However, the following embodiments are merely specific examples of a power source apparatus, and vehicle and power storage system equipped with the power source apparatus representative of the technology associated with the present invention, and the power source apparatus, and vehicle and power storage system equipped with the power source apparatus of the present invention are not limited to the embodiments described below. Further, components cited in the claims are in no way limited to the components indicated in the embodiments. In particular, in the absence of specific annotation, structural component features described in the embodiment such as dimensions, raw material, shape, and relative position are simply for the purpose of explicative example and are in no way intended to limit the scope of the invention. Properties such as the size and spatial relation of components shown in the figures may be exaggerated for the purpose of clear explanation. In the descriptions following, components with the same name and label indicate components that are the same or have the same properties and their detailed description is appropriately abbreviated. Further, a single component can serve multiple functions and a plurality of structural elements of the invention can be implemented with the same component. In contrast, the functions of a single component can be divided among a plurality of components. In addition, explanations used to describe part of one embodiment may be used in other embodiments and descriptions.

### First Embodiment

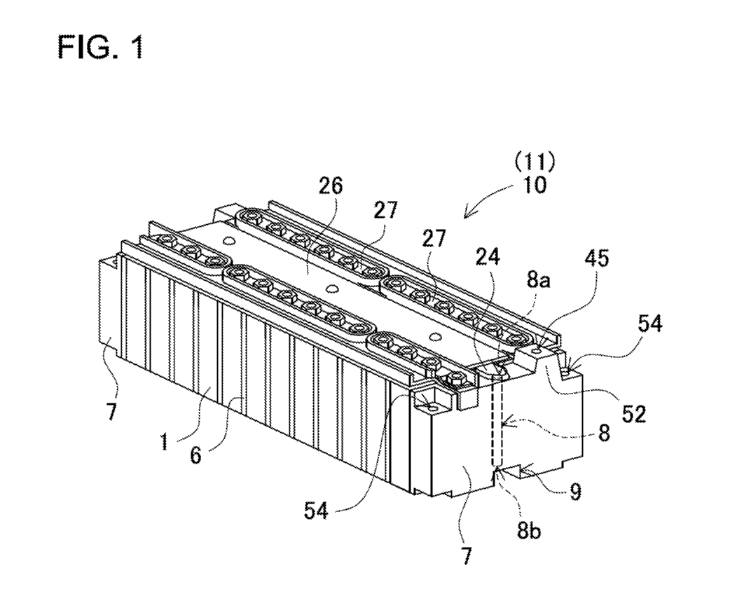

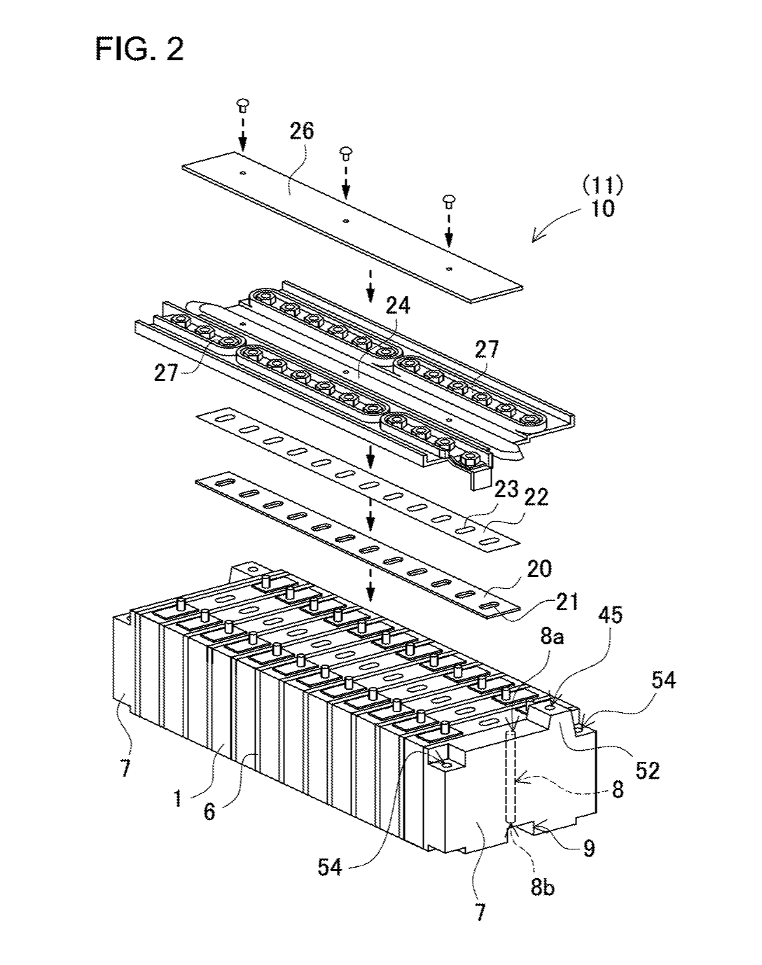

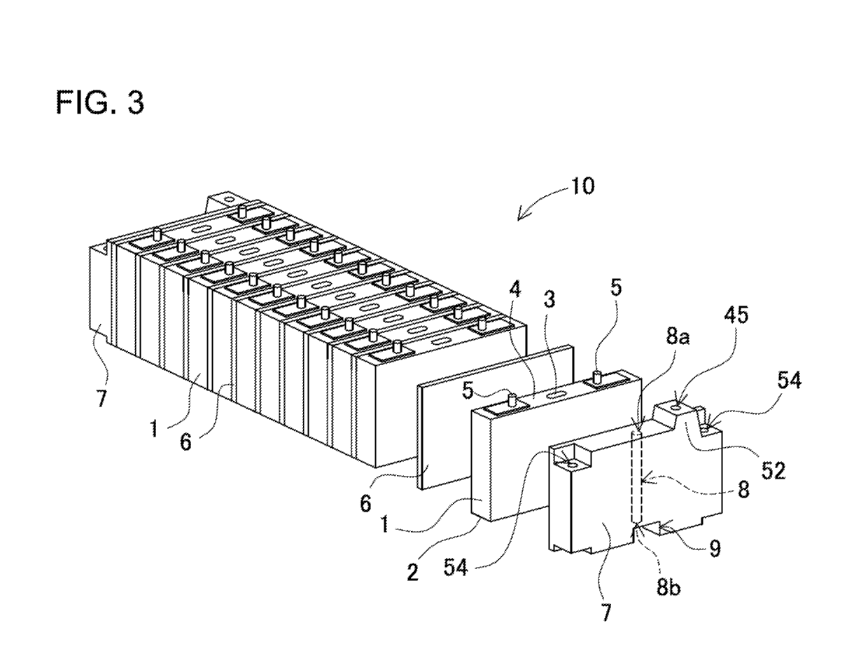

Based on FIGS. 1-3, the following describes an example of a power source apparatus used in an automotive application as the first embodiment. FIG. 1 shows an oblique view of the external appearance of a battery block 10 included in the power source apparatus, FIG. 2 shows an exploded oblique view with the safety valve gas duct 24, pressure plate 22, and sealing material 20 separated from the power source apparatus of FIG. 1, and FIG. 3 shows an exploded oblique view with a battery cell 1, separator 6, and endplate 7 separated from the power source apparatus of FIG. 1. As shown in FIG. 1, the battery block 10 has a box-shape. The power source apparatus is formed from a series and/or parallel connection of a plurality of these battery blocks 10. As shown in the exploded oblique view of FIG. 2, each battery block 10 is provided with a stack of a plurality of battery cells 1, sealing material 20, a pressure plate 22, and a safety valve gas duct 24. The safety valve gas duct 24 is connected with battery cell 1 safety valves 3.

### (Battery Block 10)

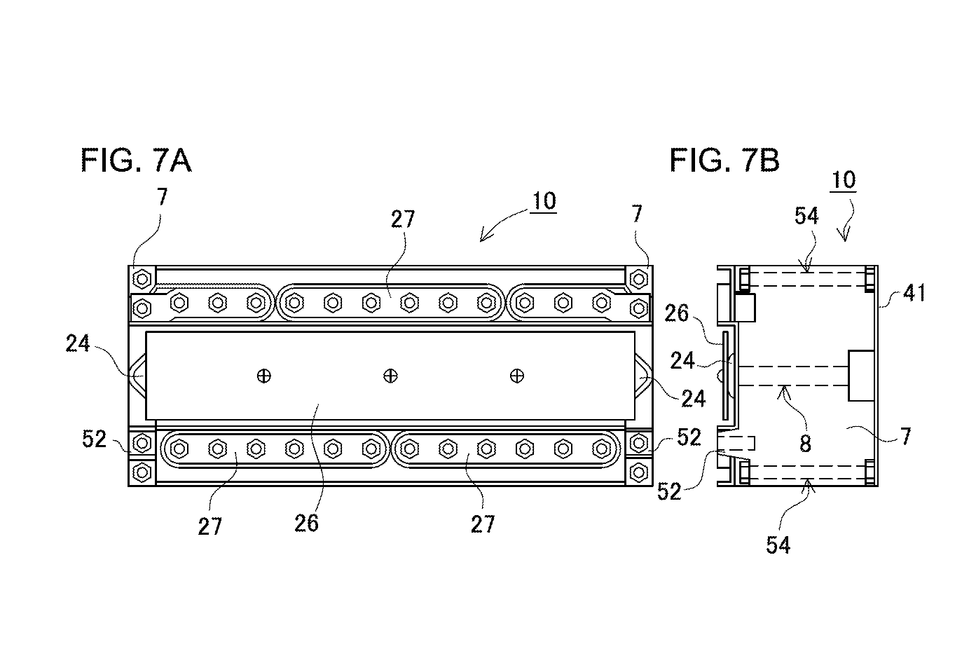

As shown in the exploded oblique view of FIG. 3, the plan view of FIG. 7A, and the end view of FIG. 7B, a battery block 10 is a plurality of battery cells 1 stacked with intervening separators 6 and held together in a block form with endplates 7 disposed at both ends. The endplates 7 at the ends of the stack are fastened together by binding bars (not illustrated). The binding bars are disposed along the sides or top of the battery block 10. The binding bars are formed by bending sheet metal. By sandwiching and holding the battery cell 1 stack between endplates 7 bound together by binding bars, the battery block 10 structure can be retained in a robust manner.

### (Battery Cell 1)

As shown in FIG. 3, a battery cell 1 employs a thin outline external case 2 having a thickness that is narrower than the lateral width of the upper surface. The external case 2 has approximately a box-shape with rounded corner regions. A sealing plate 4, which seals the upper surface of the external case 2 closed, is provided with a pair of protruding electrode terminals 5 and a safety valve 3 disposed between the electrode terminals 5. The safety valve 3 is configured to allow internal gas to be released in the event that pressure inside the external case 2 rises to a given value. The rise in pressure inside the external case 2 can be halted by opening the safety valve 3. In general, to efficiently route the gas discharged from any safety valve 3, battery cells 1 are stacked in a manner that lines-up the safety valves 3 along one surface (the upper surface in the present embodiment) of the battery block 10.

The batteries that serve as the battery cells 1 are rechargeable batteries such as lithium ion batteries, nickel hydride batteries, or nickel cadmium batteries. In particular, when thin outline lithium ion batteries are used, the power source apparatus has the characteristic that high charge capacity per overall volume can be attained.

### (Circuit Board 26)

A circuit board 26 is disposed on top of the safety valve gas duct 24. The circuit board 26 carries circuitry such as protection circuitry that monitors parameters such as the temperature and voltage of the battery cells 1 that make up the battery block 10 and checks for abnormal conditions. By disposing the circuit board on top of the battery block in this manner, there is no interference between battery blocks, and the structure is advantageous for reducing battery block size. In the example shown in FIGS. 1 and 2, bus-bars 27 that connect the electrode terminals 5 of adjacent battery cells 1 are disposed on the upper surface of the battery block 10. Bus-bars 27 extend in the battery cell 1 stacking direction as a pair of parallel rows disposed on the upper surface of the battery block 10 with separation between the two rows. By disposing the circuit board 26 between the two separated rows of bus-bars 27, battery block 10 size increase is avoided. This is advantageous for reducing overall battery block and power source apparatus size.

### (Connecting Hardware 39)

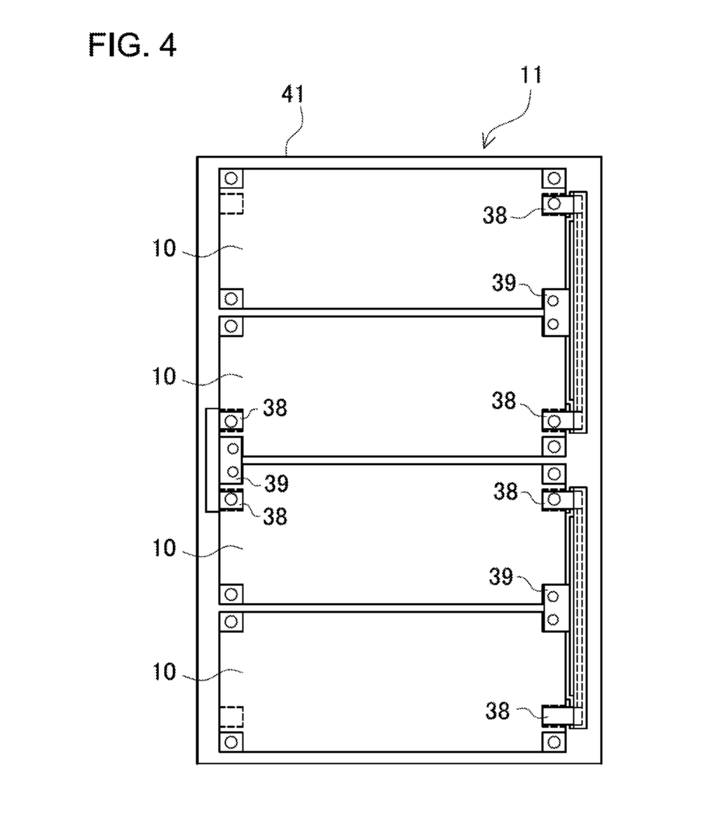

A plurality of these types of battery blocks 10 can be arranged in a horizontal plane on a base-panel 41 and joined together using connecting hardware 39. This connected arrangement is shown in the plan view of FIG. 4. The battery blocks 10 shown in this figure are provided with high voltage bus-bars 38 that electrically connect high voltage output terminals at the ends of adjacent battery blocks 10, and connecting hardware 39 that mechanically connect battery blocks 10, which are electrically connected by the high voltage bus-bars 38, at the boundary between battery blocks 10. In this example, four battery blocks 10 are arranged side-by-side in parallel orientation and connected together via connecting hardware 39 to form a battery block assembly 11.

The connecting hardware 39 have the form of brackets, and the connecting hardware 39 and high voltage bus-bars 38, which connect the high voltage output terminals of adjacent battery blocks 10, are integrated in the form of connecting modules. With this structure, the intervals between battery blocks 10 electrically connected by high voltage bus-bars 38 are rigidly maintained. As a result, stress applied to the high voltage bus-bars 38 due to vibration and impact forces is reduced by the connecting hardware 39. This allows electrical connection between battery blocks 10 to be maintained with a margin of safety and increases reliability.

### (Floor-Panel 40)

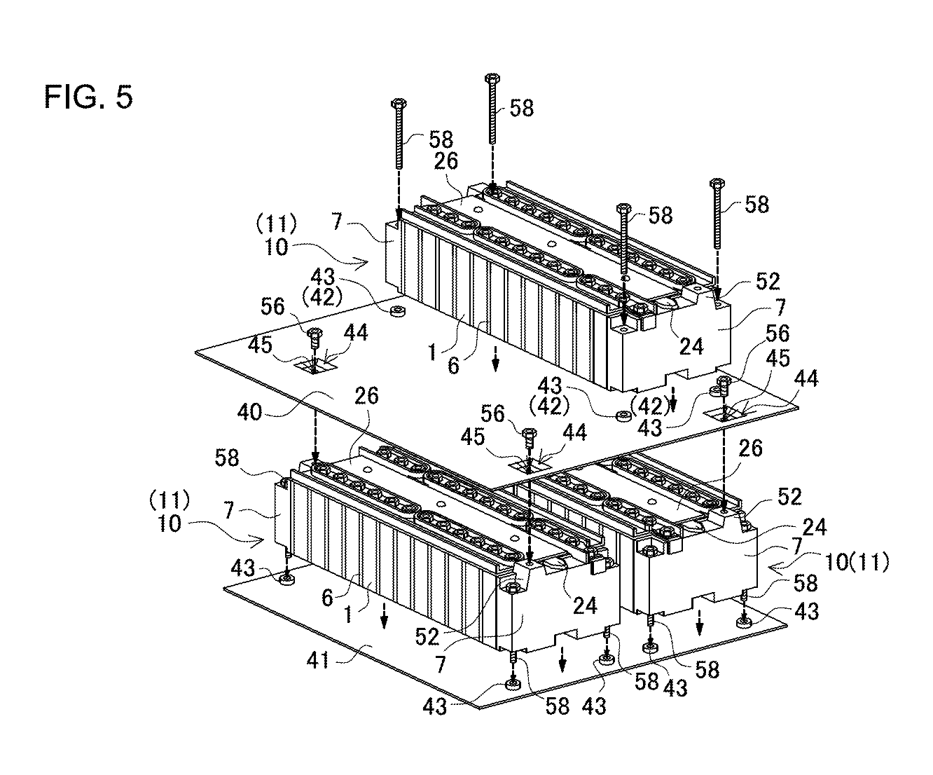

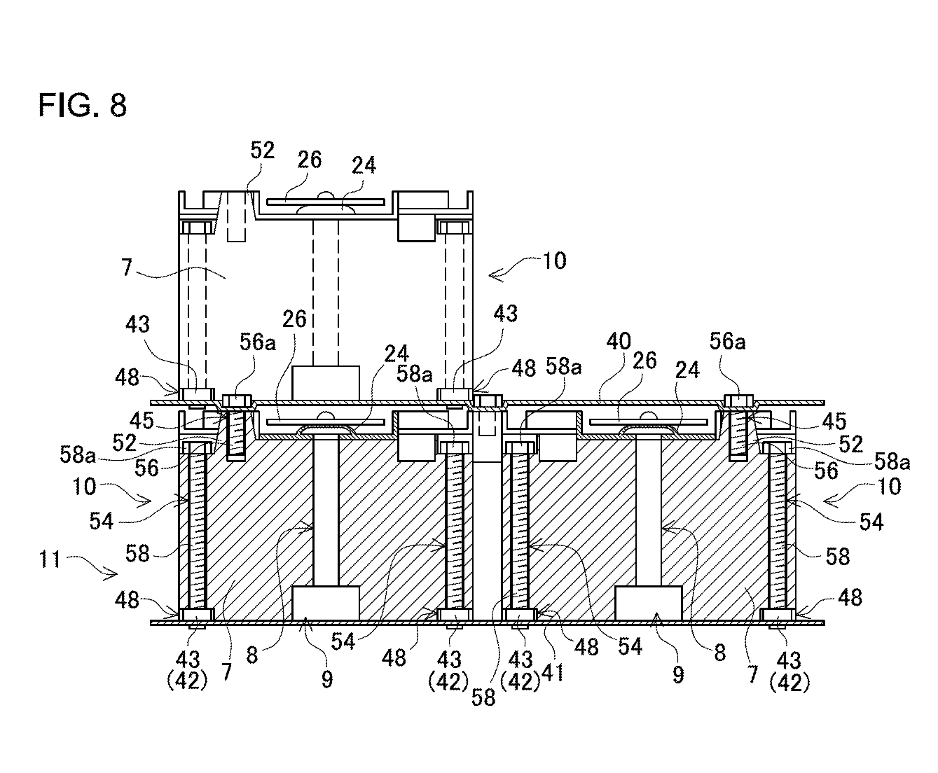

This type of battery block assembly 11, which has a plurality of battery blocks 10 joined together by connecting hardware 39, can have a floor-panel 40 attached on top, and another battery block assembly 11 can be mounted on the upper surface of the floor-panel 40. This structure is shown in the exploded oblique view of FIG. 5 and the cross-section view of FIG. 8. In the example shown in the figures, two battery blocks 10 are joined together side-by-side in parallel orientation by connecting hardware 39 in the same manner as FIG. 4 to form a battery block assembly 11 that is attached to the upper surface of a base-panel 41. Further, this battery block assembly 11, which has battery blocks 10 arranged in a horizontal plane, has another battery block 10 attached on top via an intervening floor-panel 40.

As shown in the oblique view of FIG. 5, the floor-panel 40 and base-panel 41 are made from high-strength plate material. Preferably, the floor and base-panels are metal plate that has high-strength and superior thermal conductivity. Further, in the case of floor and base-panels made of electrically conducting metal material, each site that connects with a battery block 10 is electrically insulated. This can avoid unintentional conduction between battery blocks 10.

A floor-panel 40 intervenes between lower level battery blocks 10 and upper level battery blocks 10. Consequently, a floor-panel 40 is provided with separate underside connecting structures 44 for attachment to lower level battery blocks 10, and upper surface connecting structures 42 for attachment with upper level battery blocks 10 (described later).

### (Panel Attachment Structures)

The endplates 7 of each battery block 10 are provided with panel attachment structures for attaching the battery block 10 to a floor-panel 40 and/or base-panel 41. Stated differently, a battery block 10 is attached to a floor-panel 40 and/or base-panel 41 via the endplates 7 disposed at both ends and has no panel attachment structures on separators between the ends of the battery block 10. Therefore, a (three-dimensional) layered power source apparatus can be implemented by only converting the endplates and using existing materials for other parts such as the separators. This can simplify the attachment structures for the floor and base-panels.

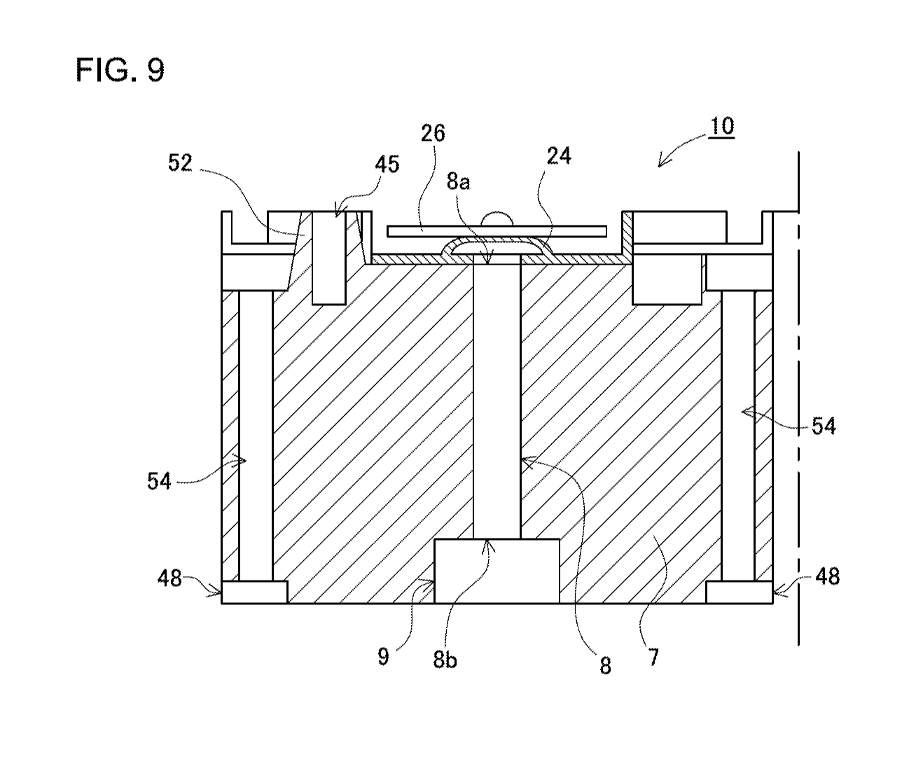

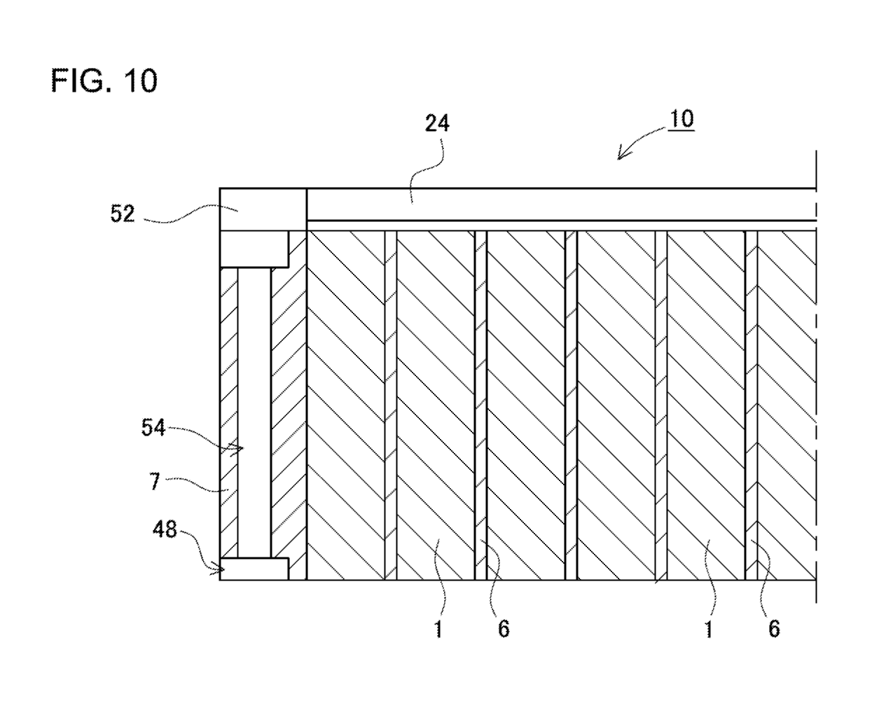

As shown in the end view of FIG. 9 and the side view of FIG. 10, an endplate 7 is provided with an upper attachment section 52 to attach a floor-panel 40 on top, and lower attachment sections 54 to attach a floor-panel 40 or base-panel 41 below.

### (Upper Attachment Section 52)

As shown in the example of FIG. 9 and other figures, an upper attachment section 52 protrudes from the upper surface of each endplate 7. In addition, a screw-hole is opened through the protruding surface. A panel underside attachment bolt 56 screws into the screw-hole.

Correspondingly, a floor-panel 40 is provided with underside connecting structures 44 on the bottom surface of the floor-panel 40 for attachment to endplate 7 upper attachment sections 52. In the example shown in the cross-section view of FIG. 8, underside connecting structures 44 include panel attachment holes 45 to attach the floor-panel 40 to the upper attachment sections 52 of the lower level battery blocks 10. Panel underside attachment bolts 56 are inserted from the top of the floor-panel 40 through the panel attachment holes 45 and screwed into the screw-holes in the endplate 7 upper attachment sections 52.

In addition, the floor-panel 40 is indented in the vicinity of each panel attachment hole 45 to form cavities that are recessed by a given height below the surface of the floor-panel 40. When the floor-panel 40 is attached via the panel attachment holes 45, the indentations position the floor-panel 40 a given height above the tops of the lower level battery blocks 10. This separates the bottom surface of the floor-panel 40 from the upper surfaces of the battery blocks 10 and electrically insulates the floor-panel 40 from the lower level battery blocks 10. Here, the upper attachment sections 52 and panel attachment holes 45 are insulated, for example, by intervening insulating material.

It is desirable for the amount of bolt extension from bolts, which pass through the floor-panel 40 from endplate 7 lower attachment sections 54 of battery blocks 10 mounted on top of the floor-panel 40, to be within the indentation height of the underside connecting structures 44. When a battery block 10 is attached on top of the floor-panel 40, this structure absorbs the bolt extension within the gap established by the underside connecting structure 44 cavities and restrains overall height increase.

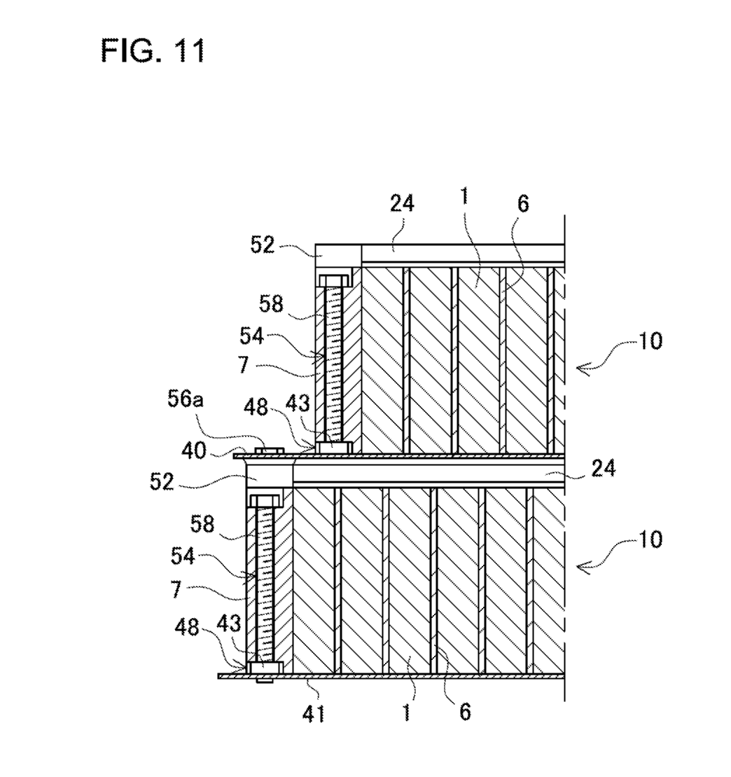

In the configuration of FIG. 8, since the heads 56a of the panel underside attachment bolts 56 protrude above the upper surface of the floor-panel 40, the bolt heads 56a will interfere with upper level battery blocks 10 mounted directly above. Therefore, as shown in the side view of FIG. 11, upper level battery blocks 10 are offset from positions directly above the lower level battery blocks 10. This avoids having to increase the overall height of the power source apparatus.

Here, the amount of cavity indentation at the panel attachment holes can be further increased, or the height of the panel underside attachment bolt heads can be reduced to keep the panel underside attachment bolt heads entirely within the panel attachment hole cavities. This structure makes it unnecessary to offset the positions of upper and lower level battery blocks, and makes it possible to stack upper and lower level battery blocks in a vertically aligned configuration.

### (Lower Attachment Section 54)

In the example of FIGS. 8 and 10, the endplate 7 lower attachment sections 54 are through-holes that pass from the upper to lower surfaces of the endplates 7. Fastener material such as bolts can be inserted from the upper surfaces of the endplates 7, passed through the lower attachment sections 54, and attached to a floor-panel 40 or base-panel 41.

Openings through endplate 7 upper surfaces for the lower attachment section 54 through-holes that pass from the upper to lower surfaces of the endplates 7 are opened through surfaces that are lower than the upper attachment section 52 surfaces. Further, the vertical difference between surfaces of the upper attachment sections 52 and the through-hole openings is greater than the height of heads 58a of the bolts 58 that pass through the lower attachment sections 54. Specifically, as shown in FIG. 8 and other figures, when bolts 58 are inserted from the upper through-hole openings through the lower attachment sections 54 to attach endplates 7 to a floor-panel 40 or base-panel 41, the bolt heads 58a are disposed in positions recessed below the upper attachment sections 52. This avoids any interference between bolt heads 58a and floor-panels 40 attached above, and also avoids overall power source apparatus height increase.

### (Upper Surface Connecting Structures 42)

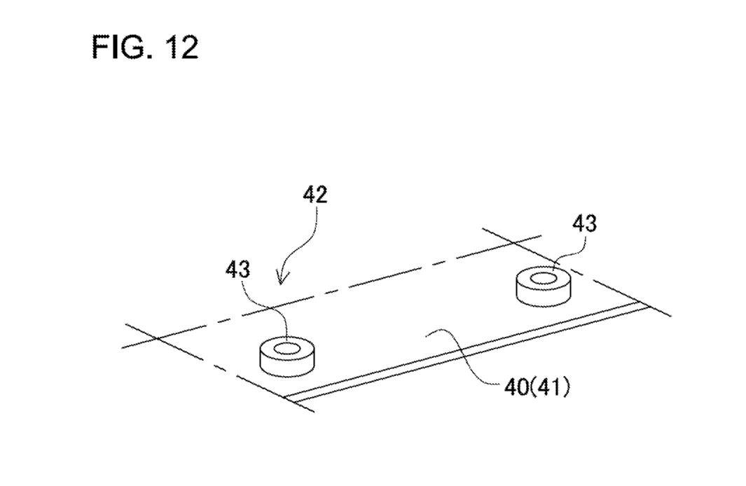

To attach battery block 10 endplates 7 to the upper surface of a floor-panel 40 or base-panel 41, battery block attachment holes are provided as upper surface connecting structures 42. As shown in the enlarged oblique view of FIG. 12, battery block attachment holes can be configured with blind nuts 43. Further, as shown in FIGS. 9 and 10, nut cavities 48 are established at the bottom surfaces of the endplates 7 to accommodate the blind nuts 43. When an endplate 7 is attached to a floor-panel 40 or base-panel 41, this structure makes it unnecessary to position nuts on the bottom side of the floor-panel 40 or base-panel 41. This results in labor-saving for attachment operations, avoids having to allocate space for nuts on the underside of the floor or base-panel, and contributes to overall size reduction.

As described above, it is possible to dispose battery blocks 10 stacked in a vertical direction via floor-panels 40. Depending on the shape of the power source apparatus installation space, battery blocks 10 can be stacked with segments of two or three levels to achieve increased flexibility in battery block 10 arrangement. Further, in a configuration where endplates 7 support high-strength floor-panels 40, there is no need to provide structures to support the floor-panels 40 at the battery cells within the battery blocks 10, and this allows the battery block 10 stacking structure to be simplified. In addition, since the battery blocks 10 can be attached in close proximity to one another via the floor-panels 40, size reduction can be achieved.

Although the floor-panel 40 and base-panel 41 in the example of FIG. 8 and other figures are made as separate parts, they can also be made as a common part. Specifically, it is also possible to use a floor-panel as a base-panel.

Also note that examples described above have a plurality of battery blocks 10 joined in a horizontal plane by connecting hardware 39 with a single battery block 10 stacked on top. However, the present invention is not limited to that configuration and, for example, the lower level can be a plurality of battery block assemblies and upper levels can be another battery block assembly that includes a plurality of battery blocks. Further, both lower and upper levels can also be single battery blocks to form a vertical stack of battery blocks.

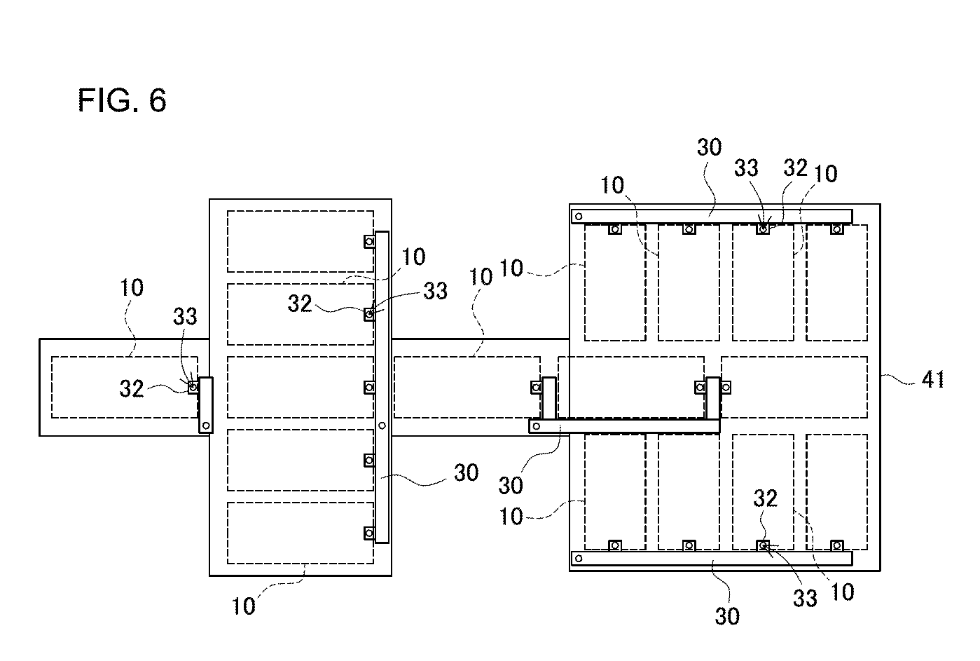

Further, battery blocks 10 disposed above or below floor-panels 40 do not necessarily have to be connected together mechanically. Specifically, it is also possible to arrange a plurality of separated battery block assemblies according to the shape of the allotted installation space. For example, as shown in the plan view of FIG. 6, when disposing a plurality of battery blocks 10 in an arbitrarily shaped space, battery blocks 10 arranged side-by-side in parallel orientation are connected together via connecting hardware while battery blocks 10 lined-up in a lengthwise direction are not connected by the same type of connecting hardware. The power source apparatus installation space is not always limited to a well structured box shaped region, and installation in a region with a complex shape must also be considered. In particular, for automotive applications, in addition to space limitations, many other vehicle components must also be installed, and power source apparatus installation space is often restricted to a complex shape. For example, as shown in the plan view of FIG. 6, situations requiring battery block arrangement in a specialized shape are inevitable. Accordingly, the ability to freely dispose battery blocks is increased while maintaining battery block assemblies using connecting hardware, but relaxing requirements to always join every battery block. This allows structures that are separated to fit in the allotted power source apparatus installation space, and allows battery block arrangement to be even more flexible. In addition, by using floor-panels in the previously described manner, battery blocks can be layered in vertically stacked configurations with a plurality of levels. Combined with horizontal arrangements, this vertical capability enables even greater battery block layout flexibility.

Each battery cell is provided with a safety valve 3 that opens to avoid internal gas pressure rise due to factors including high current charging and discharging. The power source apparatus is provided with gas exhaust ducts that channel gas out a given route. This avoids gas leakage from unintentional locations when a safety valve 3 opens to release gas inside a battery cell. Accordingly, safety valve gas ducts 24 are disposed on top of the battery blocks 10. The safety valve gas ducts 24 are designed with a strength sufficient to avoid damage when high pressure, high temperature gas is discharged. Accordingly, safety valve gas ducts 24 are preferably made from a metal such as stainless steel that has superior thermal resistance and durability. In the example shown in FIG. 2, the safety valve gas ducts 24 are formed in a hollow rectangular-shape and connect in an air-tight manner with gas exhaust duct routing (not illustrated). Gas released from a battery cell is routed through gas exhaust ducts and safely discharged to the outside. Further, sealing material 20 is provided to establish air-tight connections between safety valve gas ducts and the safety valves 3 on the battery block 10.

Resilient sheet material such as silicone resin systems can be used as the sealing material 20. As shown in FIG. 2, sealing material 20 openings 21 are established to correspond to the positions of the safety valves 3 when the sealing material 20 is mounted on top of a battery block 10. Sealing material 20 openings 21 are formed approximately the same size or slightly larger than the outside of a safety valve 3.

In addition, pressure plates 22 are provided on top of the sealing material 20 to press the sealing material 20 onto the upper surfaces of battery cell sealing plates 4 and prevent gap formation between the sealing material 20 and the sealing plates 4. By sandwiching the sealing material 20 between a pressure plate 22 and the battery cell sealing plates 4, the sealing material 20 resiliently distorts to establish an air-tight seal. In the same manner as the sealing material 20, the pressure plate 22 has pressure plate openings 23 established at positions corresponding to the safety valves 3. A safety valve gas duct 24 is attached on top of the pressure plate 22. This structure enables the safety valves 3 to connect with a safety valve gas duct 24 via the sealing material openings 21 and pressure plate openings 23. It is also desirable to apply adhesive bond at the interface between the pressure plate 22 and sealing material 20.

### (Gas Exhaust Ducts 30)

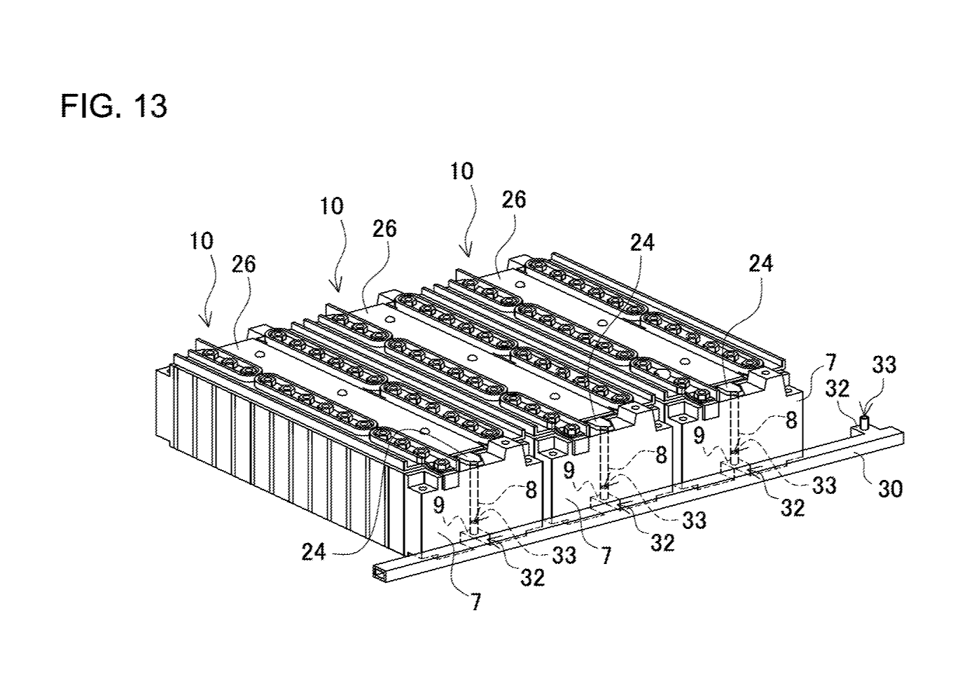

Gas exhaust ducts 30 are connected to the battery blocks 10. Turning to the example shown in FIG. 13, three battery blocks 10 are lined-up side-by-side in parallel orientation, and battery cell 1 exhaust gas routing runs from the safety valves 3 and safety valve gas ducts 24 of each battery block 10 and their connection with the gas exhaust duct 30. After being collected in a safety valve gas duct 24, gas released from any battery cell 1 safety valve 3 flows to the gas exhaust duct 30 and is safely discharged to the outside.

This gas exhaust duct 30 is not disposed at the top of the battery blocks 10 but rather is established at the bottom of the battery blocks 10. This can restrain enlargement of the battery block outline. Specifically, by disposing prior art gas exhaust ducts in convenient locations for collecting released gas at the top of the battery blocks, battery block height increase results in enlargement of the power source apparatus. This becomes an obstacle to power source apparatus installation within a limited space. If attempt is made to route exhaust gas along the sides of the battery blocks, ducting will interfere with the dedicated high-voltage wiring harness regions. Accordingly, in the present embodiment, gas exhaust ducts 30 are routed along the base of the battery blocks 10 to avoid power source apparatus enlargement and contribute to overall size reduction. In particular, by running the gas exhaust ducts 30 along the base of the sides of the battery blocks 10 or in the gaps between adjacent battery blocks 10, it becomes possible to efficiently route discharged gas. In the example shown in the plan view of FIG. 6, gas exhaust ducts 30 are disposed in gaps between a plurality of battery blocks 10 arranged in a complex pattern to form routes for discharged gas flow.

Further, in the present embodiment, endplates 7 contain endplate duct 8 plumbing that enables the flow of gas released from a battery cell 1 safety valve 3 at the top to a gas exhaust duct 30 at the bottom. This makes it unnecessary to allocate additional dedicated space for ducts to guide exhausted gas from the top of a battery cell 1 to the base of the battery blocks 10. This feature, as well, is advantageous for overall power source apparatus size reduction.

The power source apparatus described above can be used as a power source on-board a vehicle. An electric powered vehicle such as a hybrid vehicle driven by both an engine and an electric motor, a plug-in hybrid vehicle, or an electric vehicle driven by an electric motor only can be equipped with the power source apparatus and use it as an on-board power source.

### (Power Source Apparatus in a Hybrid Vehicle Application)

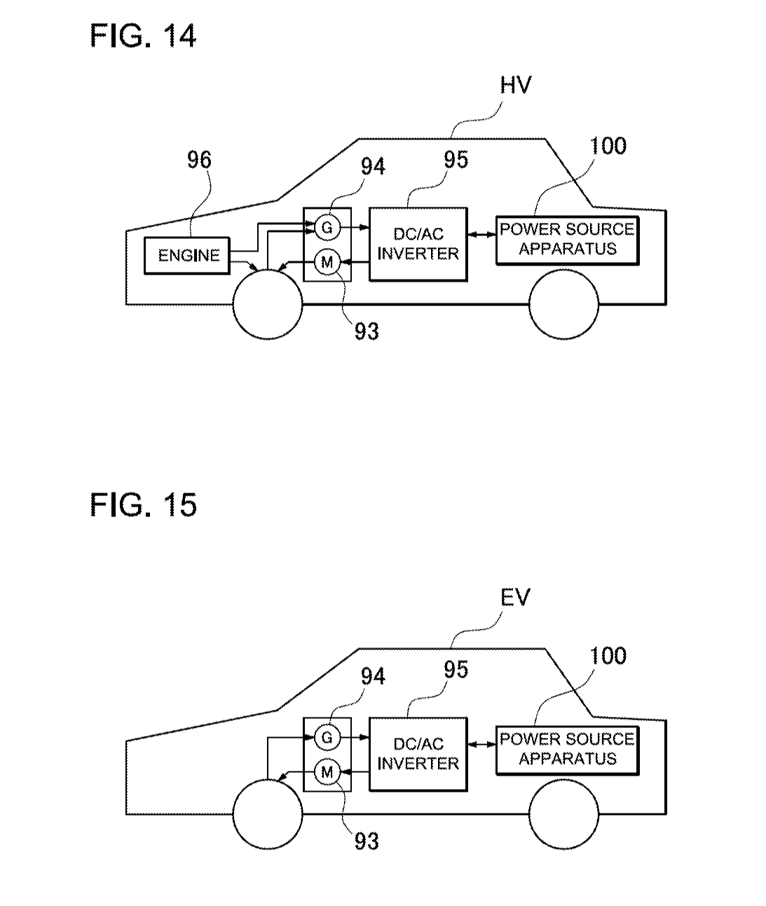

FIG. 14 shows an example of power source apparatus installation on-board a hybrid vehicle, which is driven by both an engine and an electric motor. The vehicle HV equipped with the power source apparatus 100 shown in this figure is provided with an engine 96 and a driving motor 93 to drive the vehicle HV, a power source apparatus 100 to supply power to the motor 93, and a generator 94 to charge the power source apparatus 100 batteries. The power source apparatus 100 is connected to the motor 93 and generator 94 via a direct current-to-alternating current (DC/AC) inverter 95. The vehicle HV runs on both the motor 93 and engine 96 while charging the batteries in the power source apparatus 100. In operating modes where engine efficiency is poor such as during acceleration and low speed cruise, the vehicle is driven by the motor 93. The motor 93 operates on power supplied from the power source apparatus 100. The generator 94 is driven by the engine 96 or by regenerative braking when the vehicle brake pedal is pressed and operates to charge the power source apparatus 100 batteries.

### (Power Source Apparatus in an Electric Vehicle Application)

FIG. 15 shows an example of power source apparatus installation on-board an electric vehicle, which is driven by an electric motor only. The vehicle EV equipped with the power source apparatus 100 shown in this figure is provided with a driving motor 93 to drive the vehicle EV, a power source apparatus 100 to supply power to the motor 93, and a generator 94 to charge the power source apparatus 100 batteries. The power source apparatus 100 is connected to the motor 93 and generator 94 via a DC/AC inverter 95. The motor 93 operates on power supplied from the power source apparatus 100. The generator 94 is driven by energy from regenerative braking and operates to charge the power source apparatus 100 batteries.

### (Power Source Apparatus in a Power Storage Application)

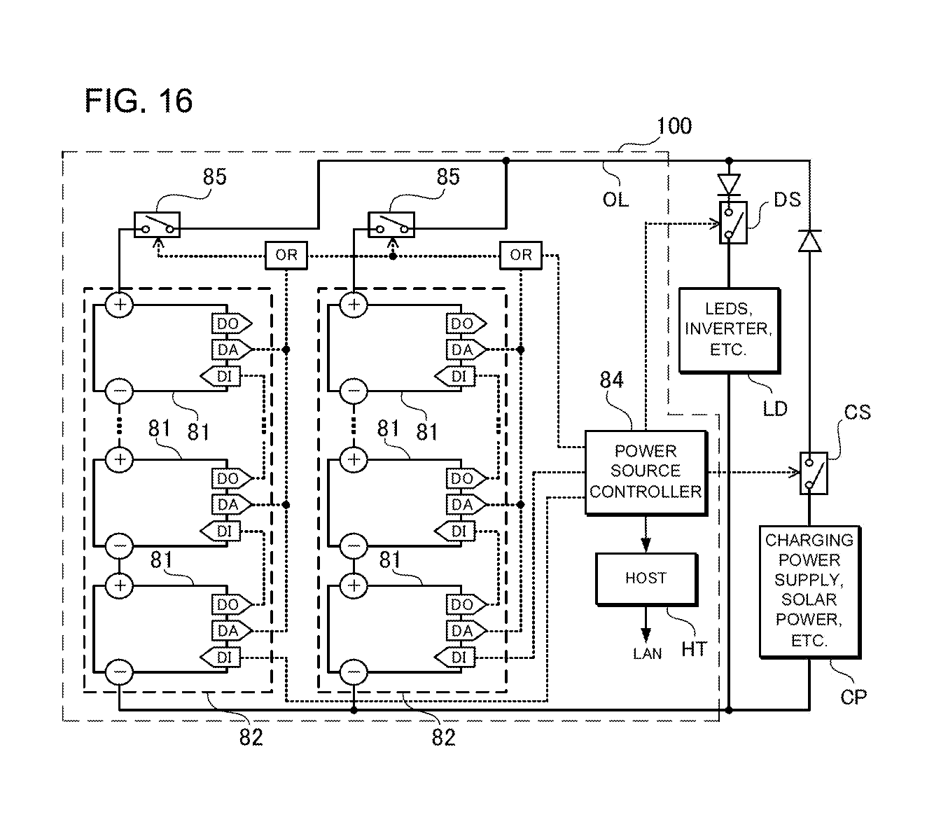

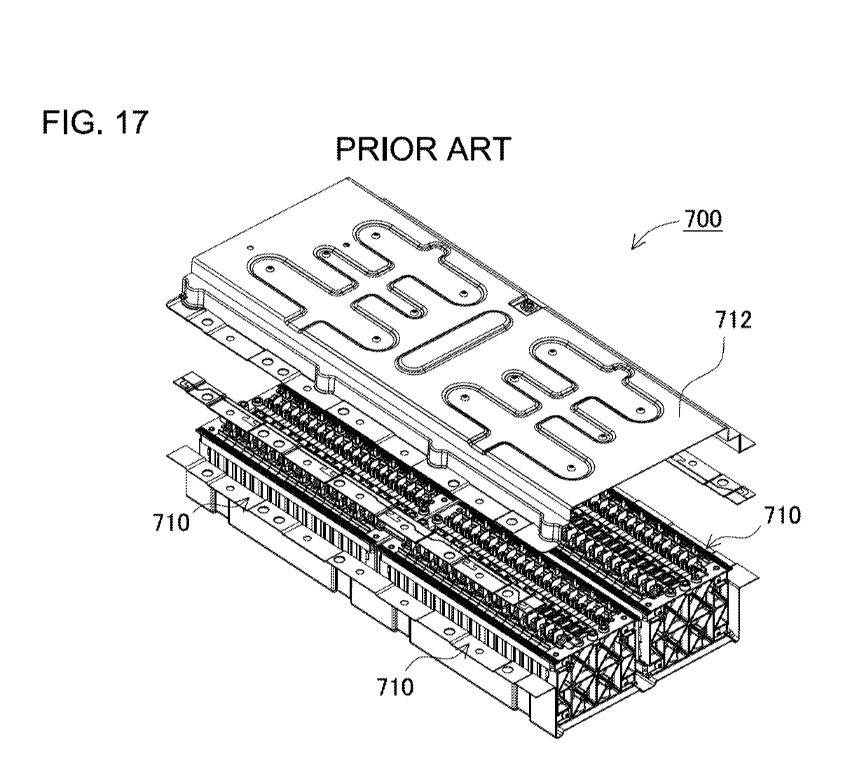

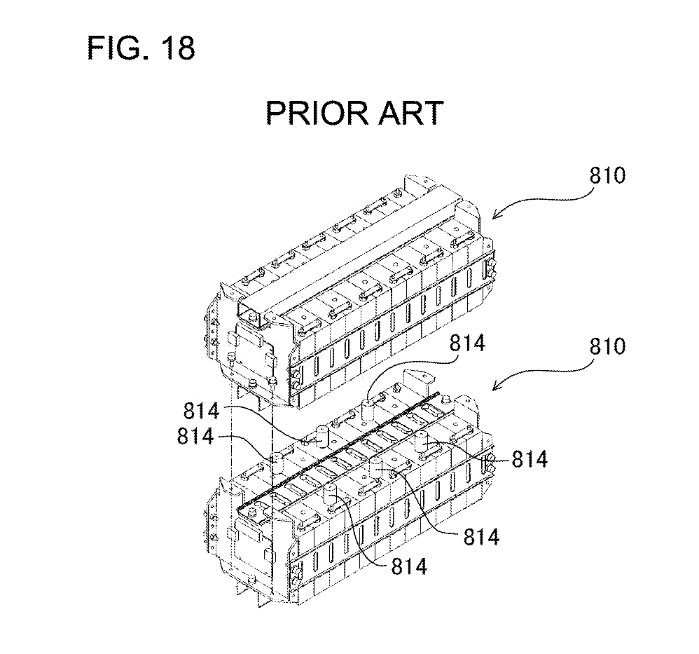

The power source apparatus can be used not only as the power source in motor vehicle applications, but also as an on-board (mobile) power storage resource. For example, it can be used as a power source system in the home or manufacturing facility that is charged by solar power or late-night (reduced-rate) power and discharged as required. It can also be used for applications such as a streetlight power source that is charged during the day by solar power and discharged at night, or as a backup power source to operate traffic signals during power outage. An example of a power source apparatus for these types of applications is shown in FIG. 16. The power source apparatus 100 shown in this figure has a plurality of battery packs 81 connected to form battery units 82. Each battery pack 81 has a plurality of battery cells connected in series and/or parallel. Each battery pack 81 is controlled by a power source controller 84. After charging the battery units 82 with a charging power supply CP, the power source apparatus 100 drives a load LD. Accordingly, the power source apparatus 100 has a charging mode and a discharging mode. The load LD and the charging power supply CP are connected to the power source apparatus 100 through a discharge switch DS and a charging switch CS respectively. The discharge switch DS and the charging switch CS are controlled ON and OFF by the power source apparatus 100 power source controller 84. In the charging mode, the power source controller 84 switches the charging switch CS ON and the discharge switch DS OFF to allow the power source apparatus 100 to be charged from the charging power supply CP. When charging is completed by fully-charging the batteries or by charging to a battery capacity at or above a given capacity, the power source apparatus can be switched to the discharging mode depending on demand by the load LD. In the discharging mode, the power source controller 84 switches the charging switch CS OFF and the discharge switch DS ON to allow discharge from the power source apparatus 100 to the load LD. Further, depending on requirements, both the charging switch CS and the discharge switch DS can be turned ON to allow power to be simultaneously supplied to the load LD while charging the power source apparatus 100.

The load LD driven by the power source apparatus 100 is connected through the discharge switch DS. In the discharging mode, the power source controller 84 switches the discharge switch DS ON to connect and drive the load LD with power from the power source apparatus 100. A switching device such as a field effect transistor (FET) can be used as the discharge switch DS. The discharge switch DS is controlled ON and OFF by the power source apparatus 100 power source controller 84. In addition, the power source controller 84 is provided with a communication interface to communicate with externally connected equipment. In the example of FIG. 12, the power source controller 84 is connected to an external host computer HT and communicates via known protocols such as universal asynchronous receiver transmitter (UART) and recommended standard-232 (RS-232C) protocols. Further, depending on requirements, a user interface can also be provided to allow direct user operation.

Each battery pack 81 is provided with signal terminals and power terminals. The signal terminals include a battery pack input-output terminal DI, a battery pack error output terminal DA, and a battery pack connecting terminal DO. The battery pack input-output terminal DI allows output and input of signals to and from the power source controller 84 and other battery packs. The battery pack connecting terminal DO allows output and input of signals to and from another related battery pack. The battery pack error output terminal DA serves to output battery pack abnormalities to components and devices outside the battery pack. In addition, the power terminals allow the battery packs 81 to be connected in series or parallel. The battery units 82 are connected in parallel to the output line OL via parallel connecting switches 85.

### INDUSTRIAL APPLICABILITY

The power source apparatus of the present invention can be appropriately used as a power source apparatus in a vehicle such as a plug-in hybrid electric vehicle that can switch between an electric vehicle mode and a hybrid vehicle mode, a hybrid (electric) vehicle, and an electric vehicle. The present invention can also be appropriately used in applications such as a server computer backup power source that can be rack-installed, a backup power source apparatus for a wireless base station such as a mobile phone base station, a power storage apparatus for the home or manufacturing facility, a streetlight power source, a power storage apparatus for use with solar cells, and a backup power source in systems such as traffic signals.

It should be apparent to those with an ordinary skill in the art that while various preferred embodiments of the invention have been shown and described, it is contemplated that the invention is not limited to the particular embodiments disclosed, which are deemed to be merely illustrative of the inventive concepts and should not be interpreted as limiting the scope of the invention, and which are suitable for all modifications and changes falling within the spirit and scope of the invention as defined in the appended claims. The present application is based on Application No. 2011-261336 filed in Japan on Nov. 30, 2011, the content of which is incorporated herein by reference.

What is claimed is:

1. A power source apparatus comprising:
a plurality of battery blocks, each battery block comprising:
a plurality of rectangular battery cells, and
endplates disposed at both ends;
a base-panel that carries battery blocks disposed in a horizontal plane; and
floor-panels disposed on top of battery blocks and configured with upper surfaces capable of carrying other battery blocks;
wherein the battery block endplates comprises:
upper attachment sections to attach a floor-panel disposed on the upper surfaces of the endplates; and
lower attachment sections to attach a base-panel or floor-panel disposed at the lower surfaces of the endplates.

2. The power source apparatus as cited in claim 1
wherein the lower attachment sections are made up of through-holes that extend from the upper to lower surfaces of an endplate,
wherein a base-panel or floor-panel disposed at the lower surface of the endplate is attached via fastener material inserted through the through-holes, and
wherein the upper attachment section is positioned laterally (in a direction perpendicular to the battery block vertical stacking direction) on the endplate outward or inward of the upper openings of the lower attachment section through-holes.

3. The power source apparatus as cited in claim 1 wherein the upper attachment section is positioned laterally (in a direction perpendicular to the battery block vertical stacking direction) on an endplate inward of the upper openings of the lower attachment section through-holes.

4. The power source apparatus as cited in claim 2
wherein the upper attachment sections are formed to protrude upward in the battery block stacking direction, and
wherein surfaces at the upper openings of the lower attachment section through-holes are formed at locations (in the battery block stacking direction) below the tops of the upper attachment sections.

5. The power source apparatus as cited in claim 4
wherein fastener material is inserted from the upper surface of a battery block endplate through the lower attachment section through-holes to attach the battery block on the upper surface of a floor-panel, and the fastener material is fastened to the floor-panel while extending from the underside of the floor-panel by a given height, and
wherein the floor-panel is provided with underside connecting structures at upper attachment section locations that extend by a given height toward the upper attachment sections on lower level battery blocks.

6. The power source apparatus as cited in claim 5
wherein the floor-panels and base-panel are provided with battery block attachment holes to attach battery block endplates to the upper surfaces, and the battery block attachment holes are configured with blind-nuts, and
wherein the bottom surfaces of the endplates are provided with nut cavities to accommodate the blind-nuts.

7. A vehicle equipped with the power source apparatus as cited in claim 1.

8. A power storage system equipped with the power source apparatus as cited in claim 1.
